(19) United States
(12) Patent Application Publication
(10) Pub. No.: US 2004/0070964 A1
(43) Pub. Date: Apr. 15, 2004

(54) Automobile instrument panel lighting fixture

(76) Inventor: Shu-Hui Lo, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/266,771

(22) Filed: Oct. 9, 2002

(51) Int. Cl. B60Q 1/26

(52) U.S. Cl. 362/29; 362/489

(57) ABSTRACT

A lighting fixture for an automobile instrument panel comprised of a backlight module; a light guide plate on the module; a light source and multiple semi-spherical grains on the guide plate sandwiched by a reflection plate and a diffusion plate; light being projected and evenly distributed on the light guide plate due to those grains; light intensity being increased by the reflection plate to be projected on the diffusion plate for the light to be evenly projected onto the instrument panel by light reflex and scattering to better illuminate the instrument panel.

### BACKGROUND OF THE INVENTION

(a) Field of the Invention

The present invention is related to an automobile instrument panel lighting fixture, and more particularly to one that has a light source to evenly distribute on a guide plate through multiple semi-spherical grains on the guide plate, then light is intensified as reflected by a reflection plate and projected on a diffusion plate for the emission from the light source to be consistently reflex and scattering on the instrument panel.

(b) Description of the Prior Art

A lighting fixture for an automobile instrument panel of the prior art, as illustrated in FIG. 1 of the accompanying drawings, is comprised of a frame 100. Three openings 101 are provided on the frame 100 with each opening 101 inserted with a panel 110 and a pointer (not illustrated) is provided on the panel 110. Said pointer swings reciprocally on the panel 110. A light guide ring 120 is each provided on the arc circumference of the panel 110. One LED 130 is each provided to both ends of the light guide ring 120. Those LEDs 130 are connected to one another by a line and a light emission drive circuit 140. The LED 130 as driven by the light emission drive circuit 140 is capable of emitting the light, which is then reflected by the light guide ring 120 to be projected on the frame 100 where a text panel is located. However, said LEDs are only provided on both sides, instead of being evenly located to the peripheral of each light guide ring 120. As the surface of the light guide ring 120 is made smooth, and the light from the LEDs 130 fails to be evenly projected all over the panel 110. Furthermore, as both LEDs 130 are respectively located on both ends of the light guide ring 120, only the light of pure color can be produced since the light form each LED 130 is projected from one single point and is prevented from being converged with the light from any other LED 130. The lighting is boring and monotonous.

### SUMMARY OF THE INVENTION

The primary purpose of the present invention is to provide a lighting fixture for an automobile instrument panel to emit the light with higher intensity to be scattered and reflected on the instrument panel. To achieve the purpose, a backlight module is provided on a casing and the instrument panel is provided on the backlight module. A light source and multiple semi-spherical grains specially designed are provided on the light guide plate sandwiched by a reflection plate and a diffusion plate. The light is projected and evenly distributed on the light guide plate due to those grains and the light intensity is increased by the reflection plate before being projected on the diffusion plate for the light to be evenly projected onto the instrument panel by light reflex and scattering to better illuminate the instrument panel

Another purpose of the present invention is to provide a lighting fixture for an automobile instrument panel to emit colorful light to make the instrument panel more interesting and attractive. To achieve the purpose, red, green and blue light sources are used so that when all three colors are scattering and reflected onto the instrument panel, various colors are produced to illuminate the instrument panel.

Another purpose of the present invention is to provide a lighting fixture for an automobile instrument panel that illuminates the instrument panel in various changes of colors. To achieve the purpose, a control circuit is provided in the casing and a switching device is provided on the control circuit. The switching device is respectively connected to a color display circuit and a light source so that when the switching device is activated to turn on both of the color display circuit and the light source, the color temperature of each color is adjusted by the color display circuit to produce various changes of colors to illuminate the instrument panel.

### BRIEF DESCRIPTION OF THE DRAWINGS

FIG. 1 is a schematic view of the prior art of the present invention.

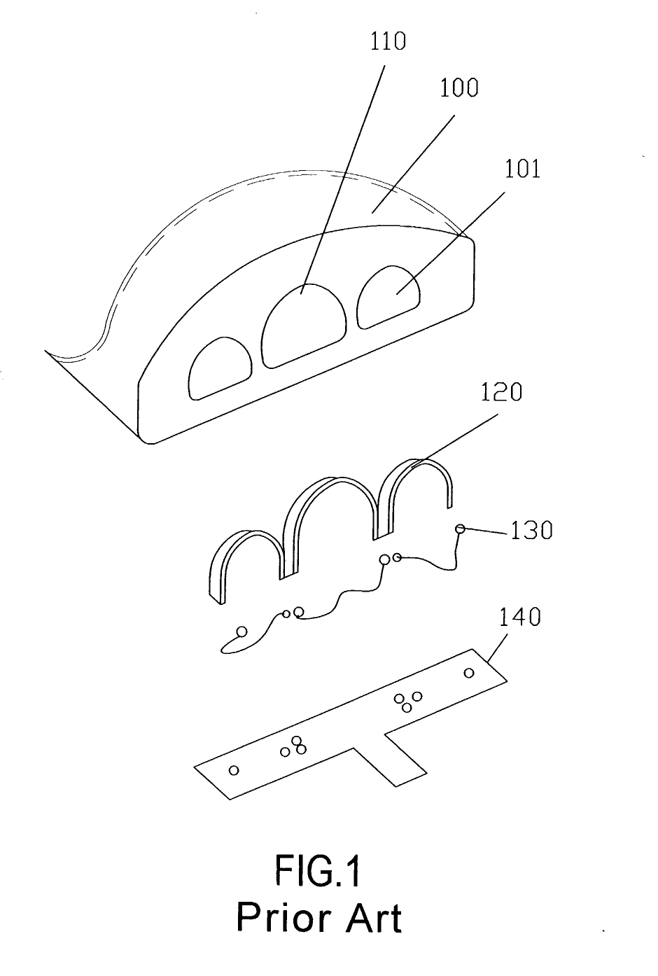

FIG. 2 is an exploded view of a preferred embodiment of the present invention.

FIG. 3 is an exploded view of a backlight module of the preferred embodiment of the present invention.

FIG. 4 is a schematic view showing an assembly of the preferred embodiment of the present invention.

FIG. 5 is a sectional view of the assembly of the preferred embodiment of the present invention.

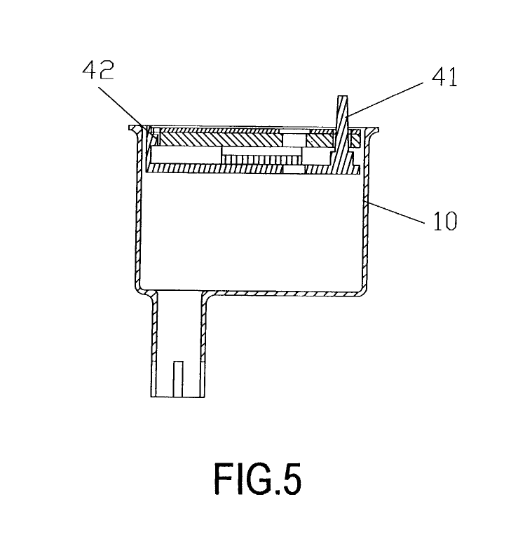

FIG. 6 is a block chart showing a control circuit of the preferred embodiment of the present invention.

FIG. 7 is a schematic view showing the control circuit of the preferred embodiment of the present invention.

### DETAILED DESCRIPTION OF THE PREFERRED EMBODIMENTS

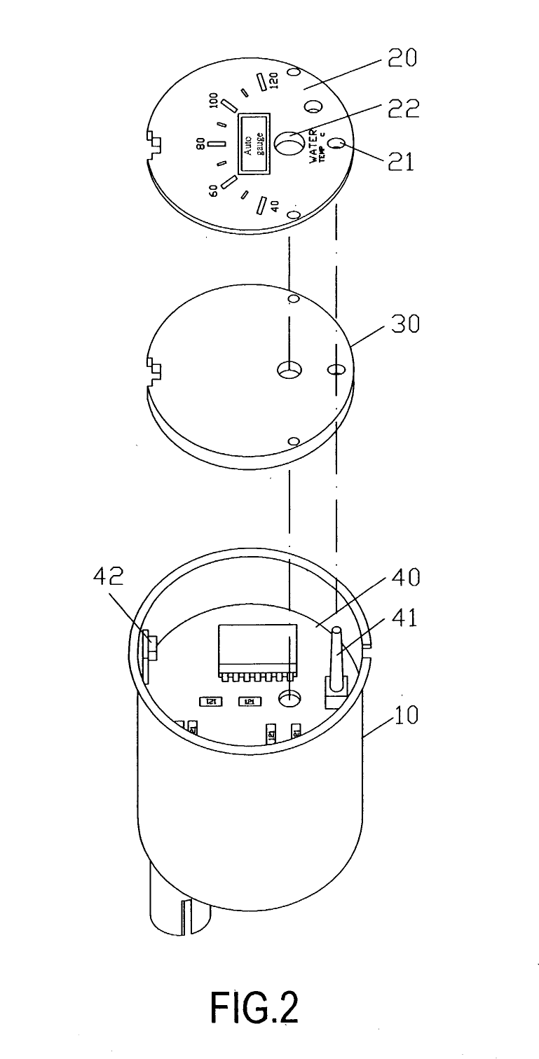

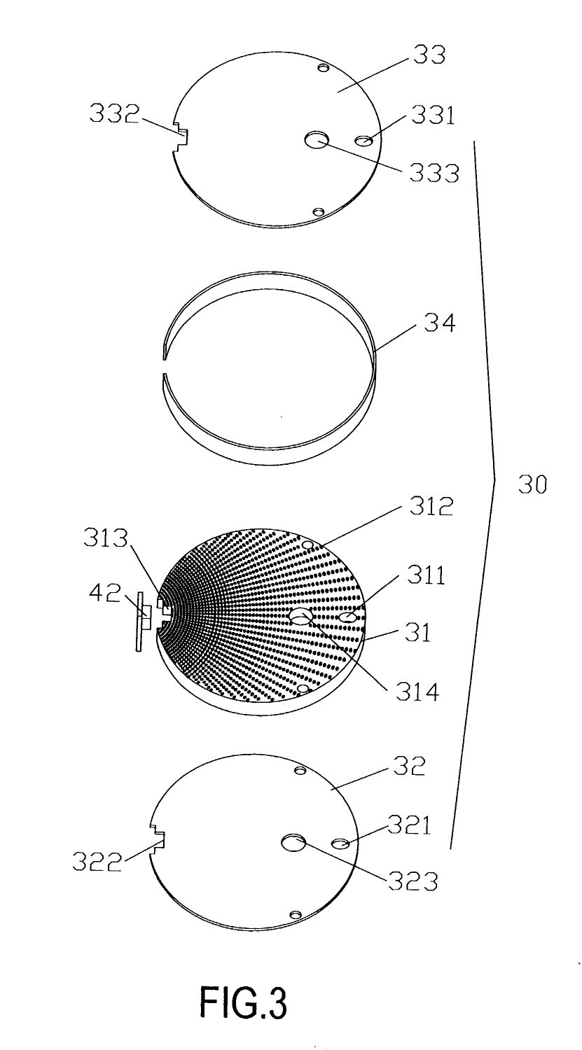

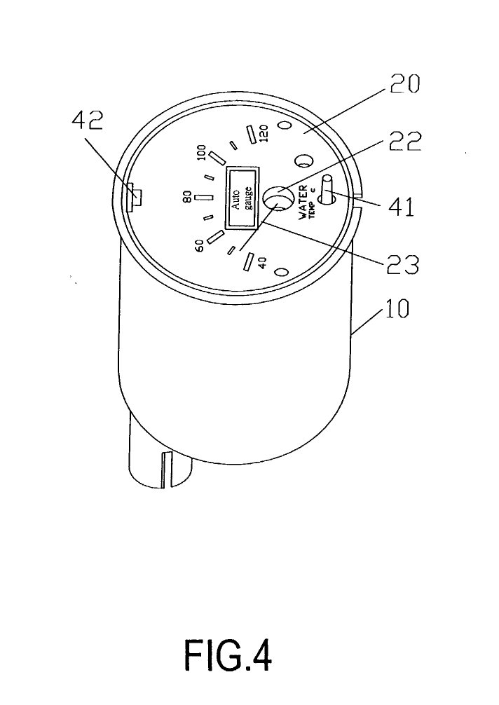

Referring to FIGS. 2 and 3, a lighting fixture for an automobile instrument panel of a preferred embodiment of the present invention is provided on a casing 10 and the casing is related to a hollow cylinder in the preferred embodiment (or to any other device that may be provided by those who are familiar with the art). An instrument panel 20 is provided on the casing 20 and a hole 21 is provided in the instrument panel 20. Another hole 22 is also provided in the instrument panel 20 to merely expose a pointer 23 to swing back and forth on the instrument panel 20 as illustrated in FIG. 4.

A backlight module 30 is provided on the casing 10 and below the instrument panel 20. As illustrated in FIG. 3, a light guide plate 31 is provided on the backlight module 30 and a hole 311 in relation to the hole 21 in the instrumental panel 20, and an opening hole 314 in relation to the hole 22. Multiple semi-spherical (or may be substituted with any other shape by those who are familiar with the art) grains 312 in various sizes are on the light guide plate 31 at locations specially designed. A recess 313 to accommodate a light source 42 is provided at a selected location on the light guide plate 31. The light source in the preferred embodiment relates to a LED (or may be substituted with any other device by those who are familiar with the art).

A reflection plate 32 made of an opaque material and a diffusion plate 33 made of transparent material are respectively adhered to where on and below the light guide plate 31. Two holes 321, 331 in relation to the hole 21 in the instrument panel 20 are respectively provided in the reflection plate 32 and the diffusion plate 33. Two openings 323, 333 in relation to the hole 22 for the pointer 23 in the instrument panel 20 are respectively provided in the reflection plate 32 and the diffusion plate 33. Two recesses 322, 332 in relation to the recess 313 in the light guide plate 31 are respectively provided in the reflection plate 32 and the diffusion plate 33. An opaque ring 34 is framed in the circumference of the light guide plate 31 to prevent any diffusion of light from the circumference of the light guide plate 31.

A control circuit 40 is provided in the casing 10. The control circuit 40 relates to a circuit board in the preferred embodiment of the present invention.

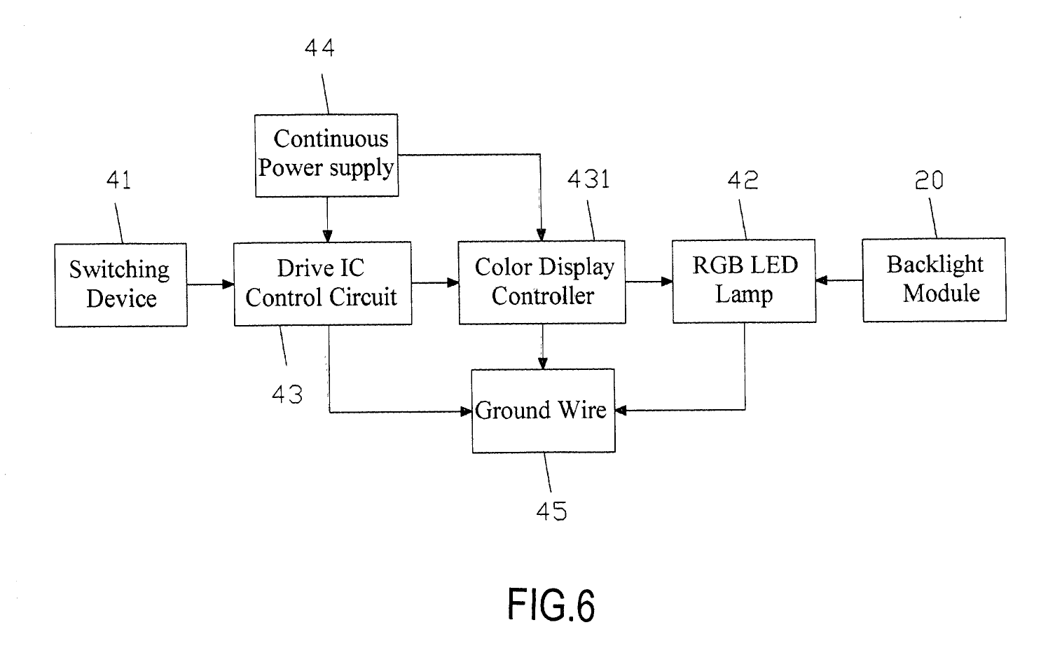

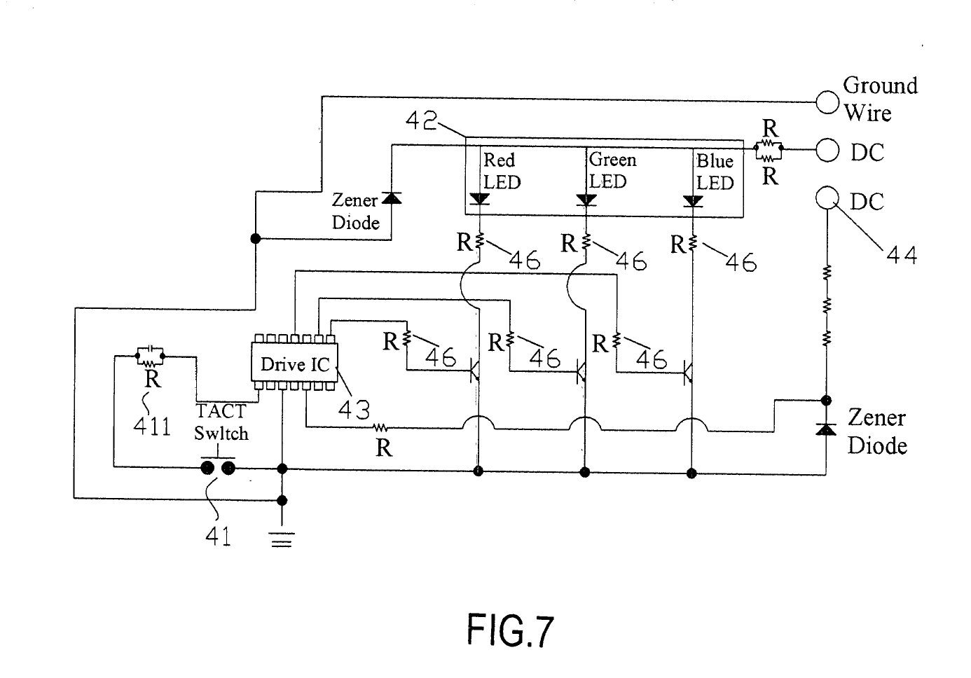

As illustrated in FIGS. 6 and 7, a switching device 41 is adapted to the control circuit 40. The switching device 41 is related to a control lever in the preferred embodiment of the present invention (or to any other device as may be substituted by those who are familiar with the art). The switching device 41 penetrates through those holes 321, 311, 331 and 21 before being exposed out of the instrument panel 20, and is connected by means of a resistance 411 to a drive circuit 43. In this preferred embodiment of the present invention, the drive circuit 43 is related to an IC (or to any other device as may be replaced by those who are familiar with the art). The drive circuit 43 contains a color display control circuit 431 to adjust the color temperature of each light source 42 and is respectively connected to light sources 42 of various colors by means of a resistance 46. In this preferred embodiment of the present invention, the light source 42 related to an RGB LCD lamp (or in any other colors as may be substituted by those who are familiar with the art). Furthermore, the switching device 41 and the drive circuit 43 are respectively connected to a power source 44. Once the switching device 41 is activated, a message is outputted to the drive circuit 43 where in turn a color display control circuit 431 of the drive circuit 43 controls the color temperature of the light source 42 connected to the color display control circuit 431, thus to adjust the color temperature emitted by the light source of different color. Consequently, once all the lights emitted from those light sources 42 are mixed, they create changes of different colors, e.g., rainbow colors.

When put in use, the switching device 41 is first activated to connect the power source 44 to the control circuit 40 for the light from the light source 42 on the control circuit to be adjusted and projected on the light guide plate 31. The light is evenly distributed on the light guide plate 31 by means of those multiple semi-spherical grains 312 provided on the light guide plate 31. As reflected by the reflection plate 32, the intensity of the light from the light source 42 is increased to be projected on the diffusion plate 33 to produce lights at higher intensity and in various colors to illuminate the instrument panel 20 by light reflex and light scattering.

As disclosed, the present invention for being innovative, offering significant improvements in the use by eliminating those defectives found with the prior art, meets the requirements of a utility patent. Therefore, this application for a utility patent is duly filed accordingly.

I claim:

1. A lighting fixture for an automobile instrument panel includes a light guide plate being provided on the backlight module, a light source being inserted to a selected location on the backlight module; multiple specially designed semi-spherical grains being provided also on the light guide plate; the light guide plate being sandwiched by a reflection plate made of opaque material above and a diffusion plate made of transparent material below characterized by that the light being projected on the light guide plate, then reflected by the reflection plate to increase the light intensity before being projected on the diffusion plate for evenly scattering and reflecting all over the entire instrument panel.

2. A lighting fixture for an automobile instrument panel as claimed in claim 1, wherein, the backlight module is accommodated in a casing.

3. A lighting fixture for an automobile instrument panel as claimed in claim 1, wherein, the light source is connected to a control circuit; a switching device being provided on the control circuit and connected to a drive circuit; and the drive circuiting containing a color display control circuit for adjustment color temperature of each individual light source.

4. A lighting fixture for an automobile instrument panel as claimed in claim 3, wherein, the switch relates to a control lever.

5. A lighting fixture for an automobile instrument panel as claimed in claim 1, wherein, the light source is related to an RGB LED lamp.
